(19) United States
(12) Patent Application Publication
(10) Pub. No.: US 2012/0054339 A1
(43) Pub. Date: Mar. 1, 2012

(54) TERMINAL DEVICE AND DIAL-UP CONNECTION ESTABLISHING METHOD USING THE TERMINAL DEVICE

(75) Inventor: YONG GAO, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 13/162,580

(22) Filed: Jun. 17, 2011

(30) Foreign Application Priority Data
Aug. 24, 2010 (CN) 201010261532.2

(51) Int. Cl. G06F 15/173

(52) U.S. Cl. 709/224

(57) ABSTRACT

In a method for establishing a dial up connection between a terminal device and a server, an inquiry packet is sent from the terminal device to a router to request parameters for establishing the dial-up connection when the terminal device dials the server. The terminal device monitors a response packet sent by the router and obtains the request parameters from the response packet, then the terminal device dials the server and sends a dial-up request packet to the server. The server assigns network connection information for the router when the dial-up request packet is received. After monitoring a feedback packet sent by the server, the terminal obtains the network connection information from the feedback packet, and updates configuration parameters of the router to establish the dial-up connection according to the network connection information.

### BACKGROUND

1. Technical Field

Embodiments of the present disclosure relate generally to network communication, and more particularly, to a terminal device and a dial-up connection establishing method using the terminal device.

2. Description of Related Art

Communication protocols associated with a network connection are usually stored and run in routers. When a terminal device needs to access to a network via a router, the router will establish a dial-up connection. However, establishing the dial-up connection will aggravate the communication burden of the routers, and increase the cost of the routers production. What is needed, therefore, is a dial-up connection establishing method using a terminal device to overcome the limitations described.

### BRIEF DESCRIPTION OF THE DRAWINGS

FIG. 1 is a schematic diagram illustrating an exemplary network system including a terminal device.

FIG. 2 is a block diagram of one embodiment of the terminal device of FIG. 1.

FIG. 3 is a flowchart of one embodiment of a method for establishing a dial-up connection using a terminal device.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

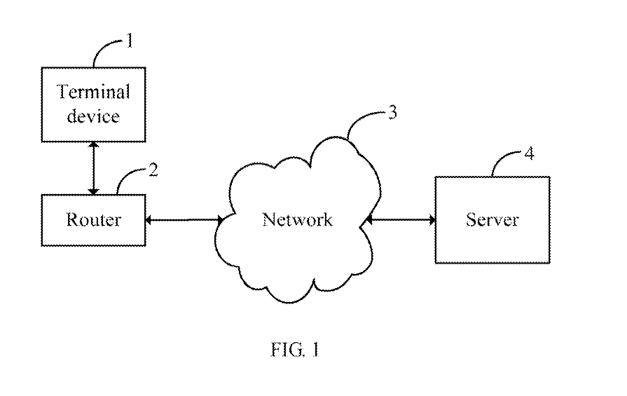

FIG. 1 is a schematic diagram illustrating an exemplary a network system including a terminal device 1. In the embodiment, several communication protocols associated with a dial-up connection are stored in the terminal device 1. The communication protocols may be a Point-to-Point protocol, or a Dynamic Host Configuration protocol, for example. The terminal device 1 connects to a router 2, and the router 2 connects to a server 4 through a network 3, such as an intranet, the Internet, or any suitable communication network. Depending on the embodiment, the terminal device 1 may be a handheld computer, a tablet computer, a desktop computer, a notebook computer, a server, or a workstation.

In one embodiment, the terminal device 1 applies to a local Internet Server Provider for an Internet account and a corresponding password for accessing the network 3. The terminal device 1 can dial the server 4 using the Internet account and the password, and communicate with the server 4 by accessing the network 3 through the router 2.

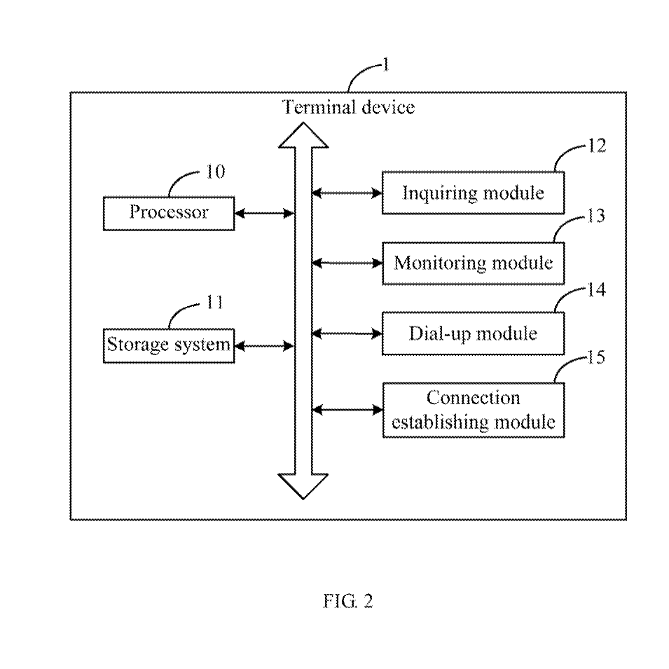

FIG. 2 is a block diagram of one embodiment of the terminal device 1 of FIG. 1. In the embodiment, the terminal device 1 includes at least one processor 10, a storage system 11, and one or more programs that comprise an inquiring module 12, a monitoring module 13, a dial-up module 14, and a connection establishing module 15. It should be apparent that FIG. 2 is only one example of the terminal device 1 that can be included with more or fewer components than shown in other embodiments, or a different configuration of the various components. In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

The terminal device 1 is generally controlled and coordinated by an operating system, such as UNIX, LINUX, WINDOWS, MAC OS X, an embedded operating system, or any other compatible operating systems. In the embodiment, the terminal device 1 provides conventional operating systems control and schedule computer processes for execution, performs memory management, provides a file system, networking, and I/O services, and provides a user interface, such as a graphical user interface (GUI).

The storage system 11 is electronically connected to the at least one processor 10, and stores the communication protocols associated with the dial-up connection. The storage system 11 is further operable to store many kinds of data, such as a customization function code of the terminal device 1, computerized codes, programs of an operating system and other applications of the terminal device 1. In the embodiment, the storage system 11 may be a hard disk drive, flash memory, RAM, ROM, cache, or external storage mediums.

The modules 12-15 may comprise computerized code in the form of one or more programs that are stored in the storage system 11. The computerized code includes instructions that are executed by the at least one processor 10 to provide functions for modules 12-15. The at least one processor 10, as an example, may include a CPU, math coprocessor, shift register, for example.

The inquiring module 12 is operable to send an inquiry packet to the router 2 to request parameters for establishing a dial-up connection between the terminal device 1 and the server 4 when the terminal device 1 dials the server 4 using an Internet account and a password input from the terminal device 1. The request parameters, for example, may include a routing table, a Media Access Control (MAC) address, and ports information of the terminal device 1.

The monitoring module 13 is operable to analyze a response packet sent by the router 2 when the response packet is monitored by the terminal device 1, and obtain the request parameters for establishing a dial-up connection between the terminal device 1 and the server 4 from the response packet. In one embodiment, the router 2 generates and sends the response packet to the terminal device 1 when the router 2 receives the inquiry packet.

The dial-up module 14 is operable to dial the server 4 by calling the communication protocols associated with the dial-up connection according to the request parameters, and send a dial-up request packet to the server 4. The dial-up request packet may also include the Internet account and the password, and is transmitted to the server 4 through the router 2 and the network 3.

The monitoring module 13 is further operable to analyze a feedback packet sent by the server 4 when the feedback packet is monitored by the terminal device 1, and obtain network connection information assigned by the server 4. The network connection information includes an Internet Protocol (IP) address, a subnet mask, a Domain Name System (DNS) address, a gateway, for example. The server 4 generates and sends the feedback packet to the network 3 when the dial-up request packet is received from the network 3, and then the router 2 transmits the feedback packet to the terminal device 1.

The connection establishing module 15 is operable to send the network connection information to the router 2, and update configuration parameters of the router 2 to establish the dial-up connection according to the network connection information. As such, the terminal device 1 can communicate with the server 4 using the configuration parameters of the router 2.

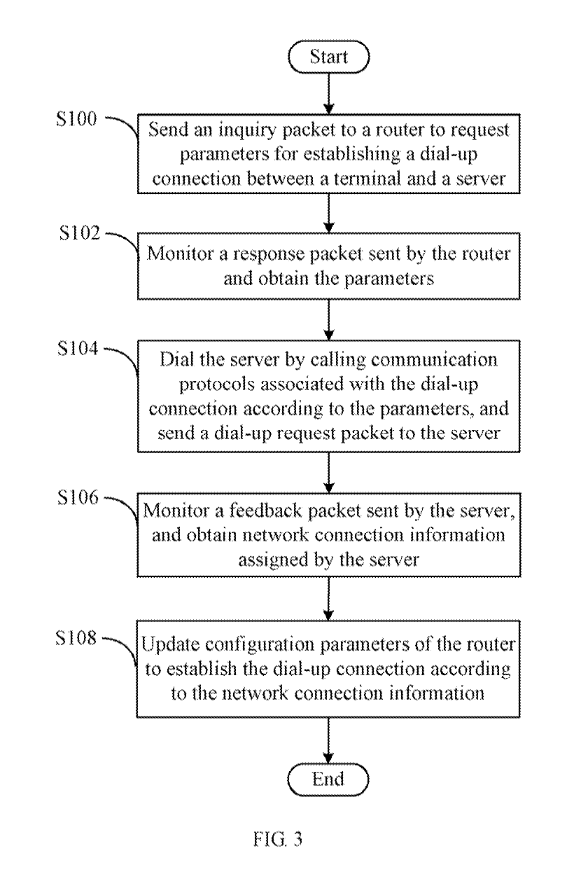

FIG. 3 is a flowchart of one embodiment of a method for establishing a dial-up connection using the terminal device 1. Depending on the embodiment, additional blocks may be added, others deleted, and the ordering of the blocks may be changed.

In block 100, the inquiring module 12 sends an inquiry packet to the router 2 to request parameters for establishing a dial-up connection between the terminal device 1 and the server 4 when the terminal device 1 dials the server 4 using an Internet account and a password input from the terminal device 1. In one embodiment, the request parameters, for example, may include a routing table, a MAC address, and ports information of the terminal device 1.

In block 102, the monitoring module 13 analyzes a response packet sent by the router 2 when the response packet is monitored by the terminal device 1, and obtains the request parameters for establishing a dial-up connection between the terminal 1 and the server 4 from the response packet. In the embodiment, the router 2 generates and sends the response packet to the terminal device 1 when the router 2 receives the inquiry packet.

In block 104, the dial-up module 14 dials the server 4 by calling the communication protocols associated with the dial-up connection according to the request parameters, and sends a dial-up request packet to the server 4. The dial-up request packet may also include the Internet account and the password, and is transmitted to the server 4 through the router 2 and the network 3.

In block 106, the monitoring module 13 analyzes a feedback packet sent by the server 4 when the feedback packet is monitored by the terminal device 1, and obtains network connection information assigned by the server 4. In the embodiment, the network connection information includes an IP address, a subnet mask, a DNS address, a gateway, for example. The server 4 generates and sends the feedback packet to the network 3 when the dial-up request packet is received from the network 3, and then the router 2 transmits the feedback packet to the terminal device 1.

In block 108, the connection establishing module 105 sends the network connection information to the router 2, and updates configuration parameters of the router 2 to establish the dial-up connection according to the network connection information. As such, the terminal device 1 can communicate with the server 4 using the configuration parameters of the router 2.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A terminal device, comprising:
a storage system;
at least one processor; and
one or more programs that are stored in the storage system and executed by the at least one processor, the one or more programs comprising:
an inquiring module operable to send an inquiry packet to a router to request parameters for establishing a dial-up connection between the terminal device and a server;
a monitoring module operable to analyze a response packet sent by the router when the response packet is monitored by the terminal device, and obtain the request parameters from the response packet;
a dial-up module operable to dial the server by calling communication protocols associated with the dial-up connection according to the request parameters, and send a dial-up request packet to the server;
the monitoring module further operable to analyze a feedback packet sent by the server when the feedback packet is monitored, and obtain network connection information assigned by the server; and
a connection establishing module operable to send the network connection information to the router, and update configuration parameters of the router to establish the dial-up connection according to the network connection information.

2. The terminal device of claim 1, wherein the terminal device connects to the router, and the router connects to the server through a network.

3. The terminal device of claim 1, wherein the communication protocols associated with the dial-up connection are stored in the storage system.

4. The terminal device of claim 2, wherein the dial-up request packet comprises an Internet account and a password for accessing the network.

5. The terminal device of claim 2, wherein the dial-up request packet is transmitted to the server through the router and the network.

6. The terminal device of claim 2, wherein the feedback packet is transmitted to the terminal device through the network and the router.

7. A method for establishing a dial-up connection using a terminal device, the method comprising:
(a) sending an inquiry packet to a router to request parameters for establishing the dial-up connection between the terminal device and a server;
(b) analyzing a response packet sent by the router when the response packet is monitored by the terminal device, and obtaining the request parameters from the response packet;
(c) dialing the server by calling communication protocols associated with the dial-up connection according to the request parameters, and sending a dial-up request packet to the server;
(d) analyzing a feedback packet sent by the server when the feedback packet is monitored by the terminal device, and obtaining network connection information assigned by the server; and
(e) sending the network connection information to the router, and updating configuration parameters of the router to establish the dial-up connection according to the network connection information.

8. The method of claim 7, wherein the terminal device connects to the router, and the router connects to the server through a network.

9. The method of claim 7, wherein the communication protocols associated with the dial-up connection are stored in a storage system of the terminal device.

10. The method of claim 8, wherein the dial-up request packet comprises an Internet account and a password for accessing the network.

11. The method of claim 8, wherein the dial-up request packet is transmitted to the server through the router and the network.

12. The method of claim 8, wherein the feedback packet is transmitted to the terminal device through the network and the router.

13. A non-transitory storage medium storing a set of instructions, the set of instructions capable of being executed by a processor of a terminal device, causes the terminal device to execute a method for establishing a dial-up connection, the method comprising:
(a) sending an inquiry packet to a router to request parameters for establishing the dial-up connection between the terminal and a server;
(b) analyzing a response packet sent by the router when the response packet is monitored by the terminal device, and obtaining the request parameters from the response packet;
(c) dialing the server by calling communication protocols associated with the dial-up connection according to the request parameters, and sending a dial-up request packet to the server;
(d) analyzing a feedback packet sent by the server when the feedback packet is monitored by the terminal device, and obtaining network connection information assigned by the server; and
(e) sending the network connection information to the router, and updating configuration parameters of the router to establish the dial-up connection according to the network connection information.

14. The medium of claim 13, wherein the terminal device connects to the router, and the router connects to the server through a network.

15. The medium of claim 13, wherein the communication protocols associated with the dial-up connection are stored in a storage system of the terminal device.

16. The medium of claim 14, wherein the dial-up request packet comprises an Internet account and a password for accessing the network.

17. The medium of claim 14, wherein the dial-up request packet is transmitted to the server through the router and the network.

18. The medium of claim 14, wherein the feedback packet is transmitted to the terminal device through the network and the router.
